(19) United States
(12) Patent Application Publication
(10) Pub. No.: US 2025/0172776 A1
(43) Pub. Date: May 29, 2025

(54) HYBRID LENS-BASED FIBER OPTIC PLUG AND RECEPTACLE CONNECTORS

(71) Applicant: CORNING RESEARCH & DEVELOPMENT CORPORATION, Corning, NY (US)

(72) Inventors: Scott Robertson Bickham, Corning, NY (US); Xinzhong Wang, Fremont, CA (US); Qijun Xiao, Fremont, CA (US)

(21) Appl. No.: 18/958,251

(22) Filed: Nov. 25, 2024

Related U.S. Application Data
(60) Provisional application No. 63/607,846, filed on Dec. 8, 2023.
(60) Provisional application No. 63/603,948, filed on Nov. 29, 2023.

(51) Int. Cl. G02B 6/42; G02B 6/028

(52) U.S. Cl. CPC G02B 6/4278; G02B 6/4204; G02B 6/421; G02B 6/4231; G02B 6/4239; G02B 6/0288

(57) ABSTRACT

Hybrid lens-based fiber optic plug and receptacle connectors are disclosed. The hybrid lens-based fiber optic plug and receptacle connectors are each respectively configured to connect with optical fibers for optical communication and electrical conductors for providing power and/or communication. The hybrid lens-based fiber optic plug and receptacle connectors each respectively comprise a lens-based ferrule body capable of supporting a dense array of optical channels along with a plurality of optional electrical contacts for optical and electrical communication if desired. In one embodiment, the array of optical channels may include an array of lenses that are suitable for use with optical fibers each having a multi-mode fiber stub. The multi-mode fiber stubs comprise a predetermined length configured as an odd multiple of a one-quarter wavelength pitch for a predetermined refractive index profile of the multi-mode fiber stubs.

### PRIORITY APPLICATION

This application claims the benefit of priority of U.S. Provisional Application No. 63/607,846, filed on Dec. 8, 2023, and U.S. Provisional Application No. 63/603,948, filed on Nov. 29, 2023, the content of which is relied upon and incorporated herein by reference in its entirety.

### FIELD

Hybrid lens-based fiber optic plug and receptacle connectors are disclosed. The hybrid lens-based fiber optic plug and receptacle connectors disclosed each respectively comprise a lens-based ferrule body capable of supporting a dense array of optical channels along with a plurality of electrical contacts for power and/or communication.

### BACKGROUND

Optical fiber is increasingly being used for a variety of applications, including but not limited to broadband voice, video, and data transmission. As bandwidth demands and capacity are increasing for communication networks it also allows for consumer devices to be developed for taking advantage of the larger bandwidth available. For instance, consumer devices like high-definition televisions and gaming consoles are being developed that require increased bandwidth for operation such as 8K television or online gaming. As the bandwidth needs for these consumer devices increases it becomes challenging for conventional electrical based cables to meet the increasing bandwidth demands for operation. Moreover, as the length of conventional electrical cables or jumpers increases the high-speed bandwidth capacity for these conventional cables or jumpers may be limited due to transmission concerns as the length increases.

In general, copper-based cable assemblies (i.e., electrically-based data transmission) become more expensive and difficult to manufacture for maintaining the desired requirements for high-speed data transmission. On the other hand, optical fibers do not have the same concerns for high-speed data transmission as conventional copper cables. For instance, the optical fibers are dielectric and not susceptible electromagnetic interference and the like. Although, the optical cables assemblies are advantageous, the use of hybrid connectors may also include electrical contacts for power or low-speed data transmission such as control signals or like in addition to the optical interface. Thus, there are advantages for hybrid fiber optic cables assemblies for consumer devices desiring high-speed data transmission and applications for using the optical channels for high-speed data transmission as bandwidth needs increase beyond the practical limits of conventional copper cable assemblies.

Thus, there exists a need for improved designs for hybrid high-density fiber optic connectors and cable assemblies that enable large bandwidth transmission while still providing a quick and easy optical connectivity for consumer devices and the like.

### SUMMARY

The disclosure is directed to a hybrid lens-based plug fiber optic connectors and complimentary hybrid lens-based receptacle fiber optic connectors along with related cables assemblies terminated by the respective hybrid lens-based fiber optic connectors. The respective hybrid cables assemblies may have another optical and/or electrical connector terminated on the second end of the cable or not as desired.

A first aspect of the disclosure is directed to a hybrid lens-based fiber optic plug connector. The hybrid lens-based fiber optic plug connector comprises a lens-based ferrule, a spring body, a plug body, at least one resilient member, a plurality of electrical contacts and a plug housing. The lens-based ferrule comprises a ferrule body having a ferrule front end and a ferrule rear end with the ferrule front end comprising one or more alignment features integrally formed in the ferrule body along with an array of lenses disposed at the ferrule front end. The spring body is formed from a dielectric material and comprises a forward end and a rearward end and at least one bore extends from the rearward end of the spring body and a spring body fiber passageway extending from the forward end to the rearward end of the spring body. The plug body comprises a plug body passageway extending from a plug body front end to a plug body rear end with the plug body passageway configured for receiving a portion of the lens-based ferrule. The resilient member is configured for biasing the lens-based ferrule to a forward position and configured for having a portion received in at least one bore of the spring body. The plug housing comprises an inner housing and an outer housing. The hybrid lens-based fiber optic plug connector is configured for being received in a hybrid lens-based fiber optic receptacle connector that may be a portion of an electronic device for optical and electrical mating.

Another aspect of the disclosure is directed to a hybrid lens-based fiber optic receptacle connector. The hybrid lens-based fiber optic receptacle connector comprises a lens-based ferrule, a plurality of electrical contacts, a receptacle body, a receptacle boot and a receptacle housing. The lens-based ferrule comprises a ferrule body having a ferrule front end and a ferrule rear end with the ferrule front end comprising one or more alignment features integrally formed in the ferrule body along with an array of lenses disposed at the ferrule front end. The receptacle body is formed from a dielectric material and comprises a receptacle body passageway extending from a receptacle body front end to a receptacle body rearend and configured for receiving a portion of the lens-based ferrule and a plurality of receptacle body channels formed from the receptacle body front end to the receptacle body rear end with each receptacle body channel being configured for receiving a portion of the respective electrical contact therein. The receptacle boot comprises a receptacle boot fiber passageway extending from a receptacle boot front end to a receptacle boot rear end. The hybrid lens-based fiber optic receptacle connector is configured for optically and electrically mating with the hybrid lens-based fiber optic plug connector.

A further aspect of the disclosure is directed to a hybrid cable assembly comprising a hybrid lens-based fiber optic plug connector and a plurality of optical fibers. The hybrid cable assembly comprises a lens-based ferrule, a spring body, a plug body, at least one resilient member, a plurality of electrical contacts and a plug housing. The lens-based ferrule comprises a ferrule body having a ferrule front end and a ferrule rear end with the ferrule front end comprising one or more alignment features integrally formed in the ferrule body along with an array of lenses disposed at the ferrule front end. The spring body is formed from a dielectric material and comprises a forward end and a rearward end and at least one bore extends from the rearward end of the spring body and a spring body fiber passageway extending from the forward end to the rearward end of the spring body. The plug body comprises a plug body passageway extending from a plug body front end to a plug body rear end with the plug body passageway configured for receiving a portion of the lens-based ferrule. The resilient member is configured for biasing the lens-based ferrule to a forward position and configured for having a portion received in at least one bore of the spring body. The plug housing comprises an inner housing and an outer housing. The plurality of optical fibers comprise a plurality of single-mode optical fibers in optical communication with the array of lenses and each one of the plurality of optical fibers comprise a respective multi-mode fiber stub attached on a respective end of the plurality of optical fibers at a transition location.

Yet another aspect of the disclosure is directed to a hybrid cable assembly comprising a lens-based fiber optic receptacle connector and a plurality of optical fibers. The hybrid cable assembly comprises a lens-based ferrule, a plurality of electrical contacts, a receptacle body, a receptacle boot, and a receptacle housing. The lens-based ferrule comprises a ferrule body having a ferrule front end and a ferrule rear end with the ferrule front end comprising one or more alignment features integrally formed in the ferrule body along with an array of lenses disposed at the ferrule front end. The receptacle body is formed from a dielectric material and comprises a receptacle body passageway extending from a receptacle body front end to a receptacle body rearend and configured for receiving a portion of the lens-based ferrule and a plurality of receptacle body channels formed from the receptacle body front end to the receptacle body rear end with each receptacle body channel being configured for receiving a portion of the respective electrical contact therein. The receptacle boot comprises a receptacle boot fiber passageway extending from a receptacle boot front end to a receptacle boot rear end. The hybrid lens-based fiber optic receptacle connector is configured for optically and electrically mating with the hybrid lens-based fiber optic plug connector. The plurality of optical fibers comprise a plurality of single-mode optical fibers in optical communication with the array of lenses and each one of the plurality of optical fibers may comprise a respective multi-mode fiber stub attached on a respective end of the plurality of optical fibers at a transition location.

Each one of the plurality of the multi-mode fiber stubs of the hybrid cable assemblies may comprise a predetermined length L, where the predetermined length L is configured as an odd multiple of a one-quarter wavelength pitch for the multi-mode fiber stubs used in the respective hybrid cable assembly.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the concepts and are incorporated into and constitute a part of this specification. The drawings illustrate various embodiments and together with the description serve to explain the principles and operation.

### BRIEF DESCRIPTION OF THE FIGURES

FIG. 1 shows explanatory first and second hybrid cable assemblies respectively having a hybrid lens-based fiber optic receptacle connector terminated on the first end of first cable assembly and a hybrid lens-based fiber optic plug connector terminated on the first end of the second cable assembly that cooperate directly for optical and electrical mating according for the concepts disclosed herein;

FIG. 1A shows the explanatory first and second hybrid cable assemblies of FIG. 1 with the first hybrid cable assembly having the hybrid lens-based fiber optic receptacle connector being a portion of an electronic device as represented by the box and being suitable for optical and electrical mating of the electronic device according for the concepts disclosed herein;

FIG. 2 depicts a bottom view of the assembled hybrid lens-based fiber optic receptacle connector of FIG. 1;

FIG. 3 shows a partially exploded view of the hybrid lens-based fiber optic receptacle connector of FIG. 2;

FIG. 4 is a perspective view of the lens-based ferrule used for both the hybrid lens-based fiber optic receptacle connector and the hybrid lens-based fiber optic plug connector of FIGS. 1 and 1A;

FIGS. 5A-5D depict various views of the receptacle body of the hybrid lens-based fiber optic receptacle connector of FIGS. 1-3;

FIGS. 6A-6D depict various views of the receptacle boot of the hybrid lens-based receptacle fiber optic connector of FIGS. 1-3;

FIGS. 7A-7C depict various views of the electrical contact configured for being received in the hybrid lens-based fiber optic receptacle connector of FIGS. 1-3;

FIGS. 8A-8D depict various views of the receptacle housing of the hybrid lens-based fiber optic receptacle connector of FIGS. 1-3;

FIG. 9 depicts a cross-sectional view showing the assembled hybrid lens-based fiber optic receptacle connector and the assembled hybrid lens-based fiber optic plug connector of FIGS. 1 and 1A aligned for optical mating;

FIG. 10 shows a partially exploded view of the hybrid lens-based fiber optic plug connector of FIGS. 1 and 1A;

FIG. 11 shows a partially assembled view of the hybrid lens-based fiber optic plug connector of FIG. 10;

FIGS. 12A-12D depict various views of the spring body of the hybrid lens-based fiber optic plug connector of FIGS. 10 and 11;

FIGS. 13A-13D depict various views of the plug body of the hybrid lens-based fiber optic plug connector of FIGS. 10 and 11;

FIGS. 14A-14D depict various views of the outer housing of the hybrid lens-based fiber optic plug connector of FIGS. 10 and 11;

FIGS. 15A-15C depict various views of the electrical contact configured for being received in the hybrid lens-based fiber optic plug connector of FIGS. 10 and 11;

FIGS. 16A-16D depict various views of the inner housing of the hybrid lens-based fiber optic plug connector of FIGS. 10 and 11;

FIG. 17 is a cross-sectional view of an explanatory cable jacket that may be used with the hybrid cable assembly concepts disclosed herein; and

FIG. 18 is a cross-sectional view of an explanatory hybrid cable that may be used with the hybrid cable assemblies disclosed herein.

### DETAILED DESCRIPTION

Reference will now be made in detail to the embodiments of the disclosure, examples of which are illustrated in the accompanying drawings. Whenever possible, like reference numbers will be used to refer to like components or parts.

The concepts disclosed herein are directed to hybrid lens-based fiber optic connectors that may be terminated on optical fibers and/or electrical conductors as desired. As disclosed herein, the hybrid lens-based fiber optic connectors whether configured as a plug or a receptacle support optical and electrical connectivity with a lens-based optical interface for transmitting or receiving optical signals at the optical interface.

The explanatory hybrid lens-based fiber optic connectors disclosed are configured as complementary receptacle and plug fiber optic connectors for direct optical mating between at the respective lens interfaces of the receptacle and plug fiber optic connectors. Likewise, electrical connections may be made between the receptacle and plug fiber optic connectors using respective electrical contacts in the receptacle and plug fiber optic connectors. Further, the hybrid lens-based fiber optic receptacle connector may be a portion on an electronic device such as television, gaming console or the like.

The hybrid lens-based fiber optic connectors disclosed may be terminated to a plurality of optical fibers on a first end, thereby forming a cable assembly. For instance, the hybrid lens-based fiber optic receptacle connector may be terminated to a plurality of optical fibers that are a portion of an electronic device with the hybrid lens-based fiber optic receptacle connector configured for optical mating at an outer surface of the electronic device and the cable assembly disposed within the electronic device and in communication with a transceiver or the like as desired. The companion hybrid lens-based fiber optic plug connector may be terminated to another plurality of optical fibers on a first end as well, thereby forming a jumper cable assembly. Thus, the hybrid lens-based fiber optic plug connector of the jumper cable assembly may be mated and unmated with the hybrid lens-based fiber optic receptacle connector of the electronic device as desired. The second ends of respective cable assemblies may be terminated with one or more different optical or electrical connectors as desired.

The cable assembly concepts disclosed may also advantageously comprise multi-mode fiber stubs attached to respective ends of a plurality of optical fibers at a transition location and are terminated by the hybrid lens-based fiber optic connectors. The multi-mode fiber stub is attached at the end of the optical fiber in a suitable manner such as fusion-splicing and both the optical fiber and the multi-mode fiber stub are in optical communication with the lens-based ferrule of the respective connector. If used, the multi-mode stubs comprise a predetermined length from the transition location (i.e., the splice location) to the front end face of the multi-mode fiber stub that is configured as an odd multiple of a one-quarter wavelength pitch of the multi-mode fiber stub for the hybrid lens-based fiber optic connectors. The one-quarter wavelength pitch for the multi-mode fiber stub is based on the predetermined refractive index profile of the multi-mode fiber used for the multi-mode fiber stub and may vary depending on the multi-mode fiber selected for use.

By way of example, the one-quarter wavelength pitch for a multi-mode fiber used for the multi-mode fiber stub may be 270 micrometers based on the predetermined refractive index profile of the multi-mode fiber selected for use. Consequently, the odd multiples for this example of the one-quarter pitch of 270 micrometers are respectively 270 micrometers, 810 micrometers, 1350 micrometers, 1890 micrometers, 2430 micrometers, 2430 micrometers, etc. Other one-quarter wavelength pitches are possible and based on the predetermined refractive index profile of the multi-mode fiber selected for use as the multi-mode fiber stub(s) in the respective hybrid cable assembly. The length of the multi-mode fibers stubs needs to be relatively close to the one-quarter wavelength pitch for the predetermined refractive index profile for the multi-mode fiber selected such as +10 micrometers for preserving optical performance. The multi-mode fiber stubs may be mass-fusion spliced to the plurality of optical fibers and then cleaved to the desired length for the multi-mode fiber stub for creating the odd multiple of a one-quarter wavelength pitch desired. Further, the odd multiple of a one-quarter wavelength pitch may be selected to have a predetermined length so that the transition location between the multi-mode fiber stub and the optical fiber is disposed in an adhesive for protecting the transition location. For instance, the transition location may be disposed in an adhesive well of the lens-based ferrule, but other configurations are possible according to the concepts disclosed.

Further, the fiber optic connectors made according to the concepts disclose may further include a convenient connector packages for optical and/or electrical mating as needed with a compact and scalable form-factors. As devices require higher-speed data transmission the hybrid connectors advantageous offer robust and reliable connectivity for consumer devices and the like. Although, the concepts disclosed herein are suitable for high-density interconnect applications such as consumer devices, the concepts may also be used in data-centers and 5G applications and may be equally applicable to other optical applications as well including indoor, automotive, industrial, or other suitable applications.

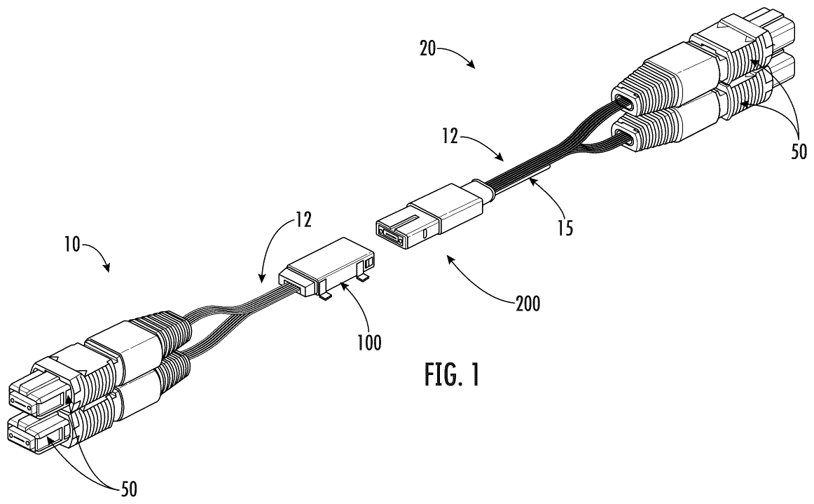

FIG. 1 shows explanatory first and second hybrid cable assemblies 10,20 according to the concepts disclosed herein. As depicted, hybrid cable assembly 10 comprises a hybrid lens-based fiber optic receptacle connector 100 terminated on the first end of first cable assembly 10. Hybrid cable assembly 20 comprises a hybrid lens-based fiber optic plug connector 200 terminated on the first end of the second cable assembly 20. The hybrid lens-based fiber optic receptacle connector 100 may directly mate and unmate with the hybrid lens-based fiber optic plug connector 200 for optical and electrical mating at the interface as desired.

The second ends of the hybrid cable assemblies 10,20 may terminate any suitable type or number of optical connectors, electrical connectors, and/or hybrid connectors as desired. As shown in FIG. 1, the optical fibers 12 are terminated at the second end by two multifiber optical connectors such as MPO type optical connectors for plug and play connectivity for the hybrid cable assemblies 10,20. In this embodiment, the electrical conductors 15 are not terminated by a connector but may be electrically connected as desired such as to a terminal block, soldered or otherwise electrically connected as appropriate.

FIG. 1A shows the explanatory first and second hybrid cable assemblies 10,20 of FIG. 1 with the first hybrid cable assembly 10 having the hybrid lens-based fiber optic receptacle connector 100 being a portion of an electronic device 1000 as schematically represented by the box drawn about hybrid cable assembly 10. This hybrid cable assembly 10 may be configured with any suitable connector on the second end or have the optical fibers 12 and/or electrical conductors 15 attached directly to a circuit board or other devices within the electronic device 1000 without terminating a suitable connector. Alternatively, the second end of hybrid cable assembly 10 may terminate a connector configured for use within the electronic device 1000 such as a connector configured for mating with a transceiver or like as desired for simplifying assembly, disassembly, maintenance, servicing, etc.

The explanatory hybrid lens-based fiber optic receptacle connector 100 and the hybrid lens-based fiber optic plug connector 200 are each configured for terminating twenty-four optical fibers 12 and three electrical conductors 15. However, other hybrid lens-based fiber optic plug connector may terminate any suitable counts of the optical fibers or electrical conductors as desired. As shown in FIGS. 1 and 1A, the MPO optical connectors 50 each terminate twelve optical fibers 12 and may be configured for any suitable transmission architecture. For instance, a first MPO connector could be for transmitting optical channels and the second MPO connector could be for receiving optical channels, but other arrangements or fiber counts are possible using the concepts disclosed.

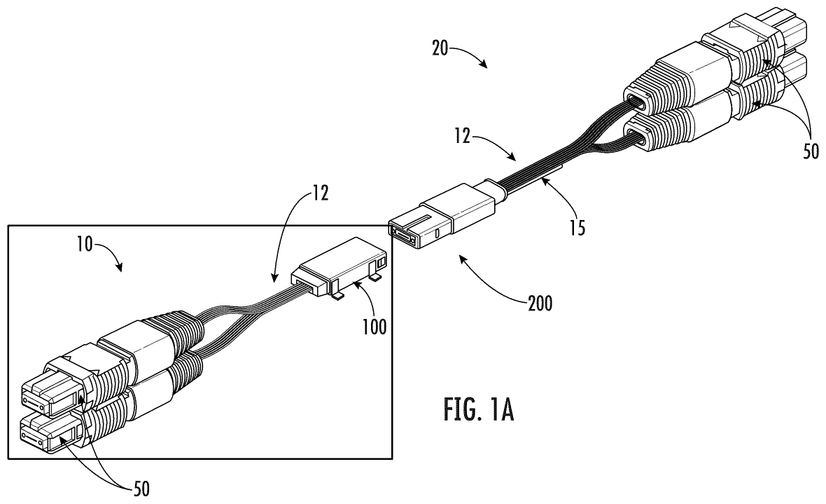

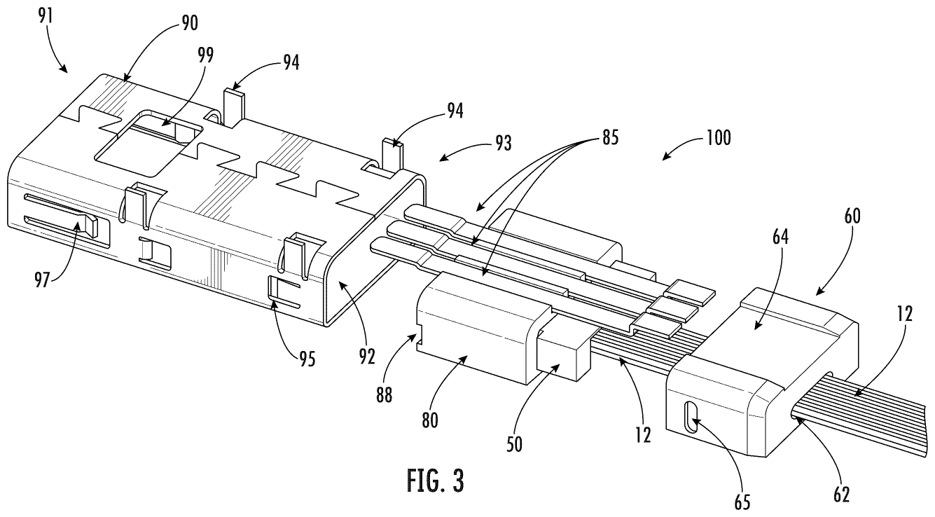

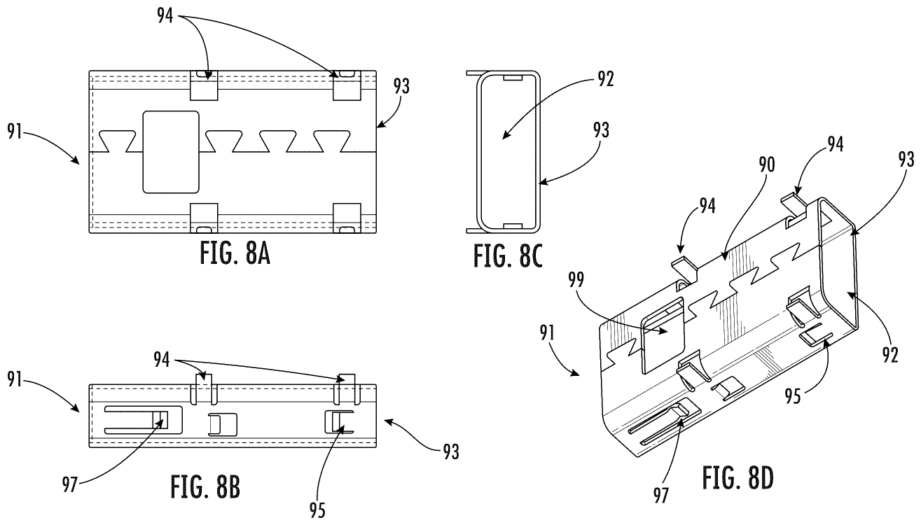

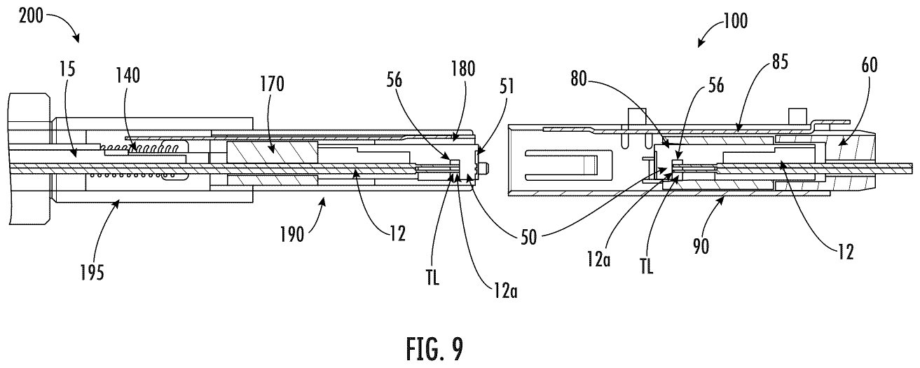

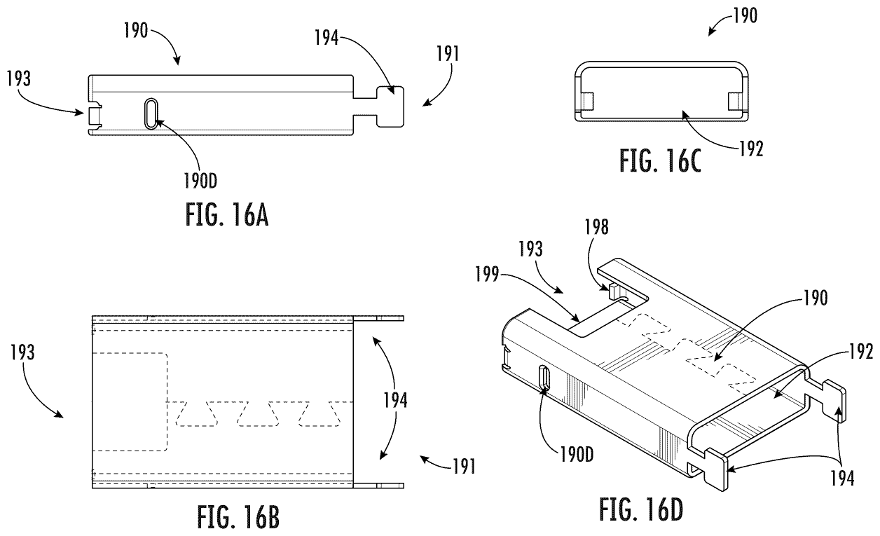

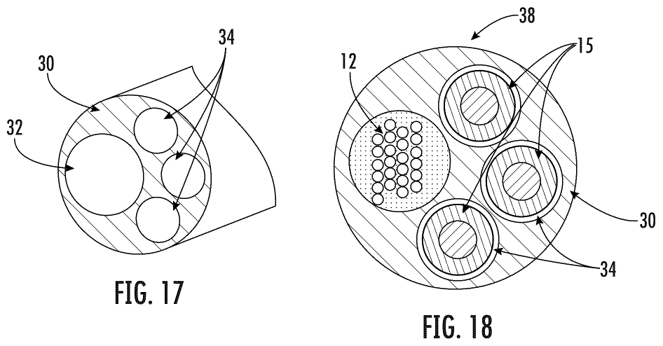

FIGS. 2-8D depict details and components of the hybrid lens-based fiber optic receptacle connector 100 of FIGS. 1 and 1A. FIG. 4 shows a perspective view of the lens-based ferrule 50 that may advantageously be used with both the hybrid lens-based fiber optic receptacle connector 100 and the hybrid lens-based fiber optic plug connector 200 of FIGS. 1 and 1A. FIG. 9 shows a cross-sectional view of the assembled hybrid lens-based fiber optic receptacle connector 100 and the assembled hybrid lens-based fiber optic plug connector 200 aligned for optical and electrical mating. FIGS. 10-16D depict details and components of the hybrid lens-based fiber optic plug connector 100 of FIGS. 1 and 1A. FIG. 17 depicts an explanatory cable jacket 30 that may be used for hybrid cable assemblies 10,20 if desired, and FIG. 18 depicts an explanatory hybrid cable 38 that may be used for hybrid cable assemblies 10,20 if desired, but other suitable jackets or hybrid cables are possible for use with the hybrid cable assemblies 10,20.

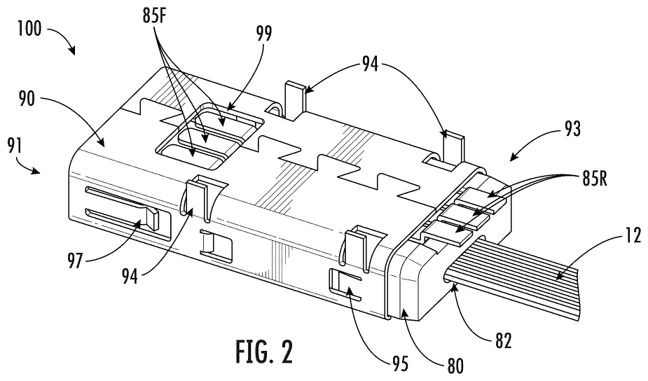

FIG. 2 depicts a bottom view of the assembled hybrid lens-based fiber optic receptacle connector 100, and FIG. 3 shows a partially exploded view of the hybrid lens-based fiber optic receptacle connector 100 of FIG. 2. As best shown in FIG. 3, the hybrid lens-based fiber optic receptacle connector 100 comprises a lens-based ferrule 50, a receptacle body 80 formed from a dielectric material, a receptacle boot 60, a plurality of electrical contacts 85, and a receptacle housing 90. When assembled, the hybrid lens-based fiber optic receptacle connector 100 is configured for receiving a portion of the hybrid lens-based fiber optic plug connector 200 within its receptacle housing 90 as depicted in FIG. 9. Consequently, the opening of the receptacle housing 90 at a first end 91 may be presented at a surface of an electronic device 1000 with the remainder disposed within the electronic device 100.

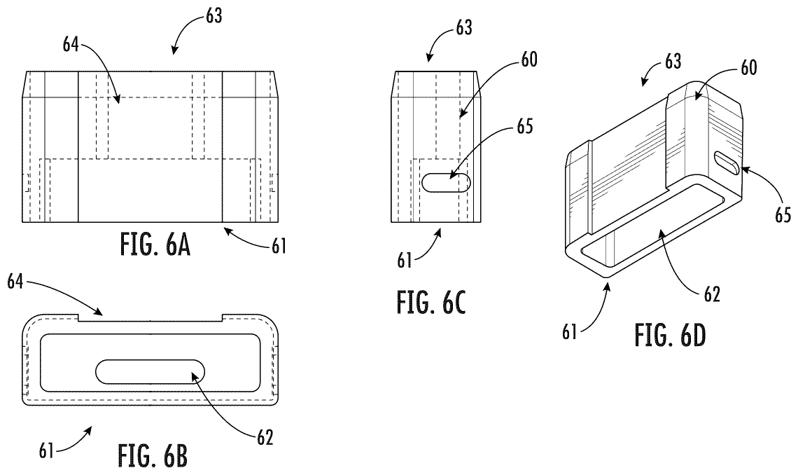

As shown in FIG. 3, the lens-based ferrule 50, receptacle body 80, receptacle boot 60, and the plurality of electrical contacts 85 are removed from the receptacle housing 90. The receptacle body 80 comprises a receptacle body passageway 82 that extends from a receptacle body front end 81 to the receptacle body rear end 83 and is configured for receiving a portion of the lens-based ferrule 50 as shown. When the hybrid lens-based fiber optic receptacle connector 100 is assembled the lens-based ferrule 50 and receptacle body 80 are disposed within a passageway 92 of the receptacle housing 90. Further, the electrical contacts 85 have a rear portion 85B extending beyond the rear end of the receptacle housing 90, and a front portion 85F of the electrical contacts 85 are aligned with a window 99 disposed on a bottom surface of receptacle housing 90 as shown in FIG. 2. FIGS. 7A-7C depict various views showing the details of the electrical contacts 85, which may be formed from any suitable conductive material such as discussed herein and may be sized according to the desired power requirements.

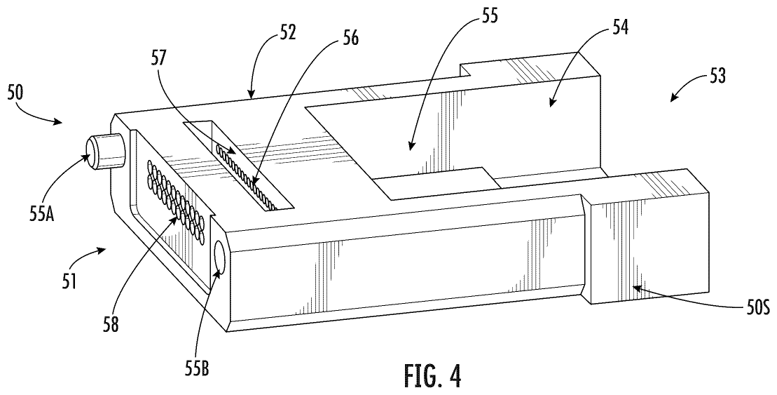

FIGS. 5A-5D depict various views showing details of the receptacle body 80. The receptacle body passageway 82 is sized so that the wider rear portion of the lens-based ferrule 50 is stopped from further insertion towards the receptacle body front end 81 as shown. The receptacle body 80 may also comprise a plurality of receptacle body channels 84 formed from the receptacle body front end 81 to the receptacle body rear end 83 with each receptacle body channel being configured for receiving a portion of a respective electrical contact 85 therein. The receptacle body channels 84 are disposed on a bottom surface of the receptacle body 80 so that when assembled the electrical contacts 85 are available for soldering to a circuit board or the like as desired. The receptacle body 80 may also have features to ensure it only fully seats into the receptacle housing 90 in one orientation for proper assembly such as offset notches 88 that cooperate with tabs on the receptacle housing 90. Offset notches 88 may also act as a forward stop for ensuring that the receptacle body 80 and in-turn the lens-based ferrule 50 are in the proper depth or Z-direction location within the receptacle housing 90 when assembled.

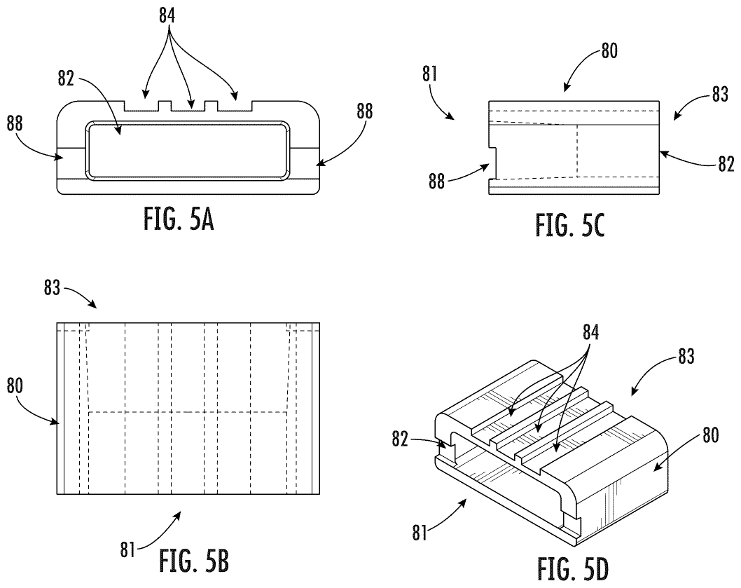

FIGS. 6A-6D depict various views showing details of the receptacle boot 60. The receptacle boot 60 comprises a receptacle boot fiber passageway 62 extending from a receptacle boot front end 61 to a receptacle boot rear end 63 so that the plurality of optical fibers 12 may extend therethough as shown. The receptacle boot 60 also has a common channel 64 disposed on its bottom surface for accommodating the electrical contacts 85 when assembled and inhibiting the electrical contacts from touching the receptacle housing 90 when assembled. The receptacle boot fiber passageway 62 has a stepped profile for allowing the rear end of the lens-based ferrule 50 to nest inside a portion of the receptacle boot 60 when assembled as shown in FIG. 9.

The receptacle boot 60 may also include one or more attachment features 65. For instance, the one or more attachment features 65 may be protrusions disposed on opposing sides of the receptacle boot 60 for cooperating with one or more respective latches 95 disposed on the receptacle housing 90. Consequently, when the respective components are aligned as shown in FIG. 3 they can be inserted into receptacle housing passageway 92 from the receptacle housing rear end 93 until the receptable boot 60 is properly seated in receptacle housing 90. By way of explanation, the one or more attachment features 65 such as protrusions expand the one or more latches 95 outward until they move past the latches 95 and allowing the latches 95 to spring back into position and capture the protrusions in a window forward of the latches 95 such as shown in FIG. 2. Thereafter, the components are assembled with a portion of the lens-based ferrule 50 sandwiched between the receptacle body 80 and the receptacle boot 60 as best shown in FIG. 9.

An optional interface pad may be included as part of the hybrid lens-based fiber optic receptacle connector 100 if desired. The interface pad may be at least partially disposed between the receptacle boot 60 and the lens-based ferrule 50 if used. The receptacle boot fiber passageway 62 can be shaped to accommodate the optical interface pad such as having the stepped profile as illustrated for fitting the interface pad within the receptacle boot fiber passageway 62. The interference pad is formed from a suitable compliant material for allowing slight movement of the lens-based ferrule 50 within the hybrid lens-based fiber optic receptacle connector 100 during optical mating. Specifically, the interface pad allows the lens-based ferrule 50 to tilt during optical mating of the hybrid lens-based fiber optic receptacle connector 100 with the hybrid lens-based fiber optic plug connector 200 as needed. By way of example, a suitable interface pad may be a formed from a rubber or elastomeric material, but other suitable materials are possible according to the concepts disclosed.

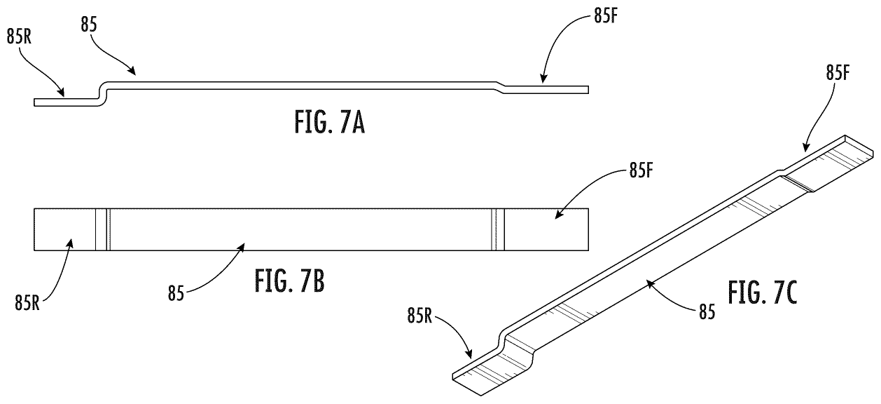

FIGS. 8A-8D depict various views showing details of the receptacle housing 90 of the hybrid lens-based fiber optic receptacle connector 100. Receptacle housing 90 comprises a receptacle housing passageway 92 extending from a receptacle housing front end 91 to a receptacle housing rear end 93. The receptacle housing 90 may be formed from a single piece of sheet metal such as nickel-plated material or the like. Receptacle housing 90 may comprise a plurality of mounting tabs 94 for securing the receptacle housing 90 to a circuit board or the like. Further, the mounting tabs 94 allow for providing a grounded receptacle housing 90 when mounted to a circuit board or electronic device if desired. Receptacle housing 90 may also include one or more mating latches 97 for providing a detent for the hybrid lens-based fiber optic plug connector 200 that may be inserted into the receptacle housing 90 for connectivity. For instance, the receptacle housing 90 may have mating latches 97 configured as rearward facing cantilevered arms disposed on opposing sides of the receptacle housing for cooperating with suitable structure of the mating hybrid lens-based fiber optic plug connector 200.

The plurality of optical fibers 12 terminate at the lens-based ferrule 50 as shown in FIG. 9. The plurality of optical fibers 12 may be single-mode optical fibers in optical communication with the array of lenses 58 of the lens-based ferrule 50. Further, each one of the plurality of optical fibers 12 may each comprise a respective multi-mode fiber stub 12a attached on an end of the respective single-mode optical fiber as depicted. The multi-mode fiber stub 12a comprises a predetermined length L that is configured as an odd multiple of a one-quarter wavelength pitch for a predetermined refractive index profile of the multi-mode fiber selected for use with the hybrid lens-based fiber optic plug connector 100. A transition location TL is defined at the interface between the single-mode optical fiber 12 and the multi-mode fiber stub 12a. Once the multi-mode fiber stub 12a is aligned and attached to the respective optical fiber 12 it becomes a portion of the optical fiber and both the optical fiber 12 and the multi-mode fiber stub 12a are in optical communication with the lens-based ferrule 50 once properly aligned and terminated in the lens-based ferrule 50.

By way of example, the predetermined one-quarter wavelength pitch for the selected multi-mode fiber may be 270 micrometers based on refractive index profile. Consequently, the odd multiples for this selected one-quarter wavelength pitch (e.g., 270 micrometers) are respectively 270 micrometers, 810 micrometers, 1350 micrometers, 1890 micrometers, 2430 micrometers, etc. The length of the multi-mode fiber stubs should be relatively close to the one-quarter wavelength pitch predetermined refractive index profile for the multi-mode fiber selected such as +10 micrometers for preserving optical performance. By way of explanation, the multi-mode fiber stubs 12a may be mass-fusion spliced to the plurality of optical fibers 12 in any suitable manner or method with a longer length than desired. Then the multi-mode fiber stubs 12a may be precision cleaved to a predetermined length that is the desired odd multiple of the one quarter wavelength pitch for the multi-mode fiber stub 12a for use with the hybrid lens-based fiber optic connectors disclosed herein. Further, the odd multiple of a one-quarter wavelength pitch may be selected to have a predetermined length so that the transition location TL between the multi-mode fiber stub and the optical fiber is disposed in an adhesive for protecting the transition location TL. For instance, the transition location may be disposed in an adhesive well of the lens-based ferrule, but other configurations are possible for protecting the transition location TL without being within an adhesive well such as having the transition location TL within a bore or the like according to the concepts disclosed.

Returning to FIG. 4, the lens-based ferrule 50 is used for both the hybrid lens-based fiber optic receptacle connector 100 and the hybrid lens-based fiber optic plug connector 200. As shown, the lens-based ferrule 50 comprises a ferrule body 52 having a ferrule front end 51 and a ferrule rear end 53. The front end 51 of the lens-based ferrule 50 may comprise one or more alignment features 55A, 55B integrally formed in the ferrule body 52. An array of lenses 58 are disposed at the ferrule front end 51.

In this embodiment, lens-based ferrule 50 has the array of lenses 58 arranged in a plurality of rows for supporting twenty-four optical channels such as two rows of twelve lenses 58. Of course, the concepts may use a single-row of lenses and/or other lens counts as desired. The alignment features 55A,55B may have any suitable construction desired. As shown, the alignment features 55A,55B are different so a single configuration of the lens-based ferrule 50 may be used for the both the hybrid lens-based fiber optic receptacle connector 100 and the hybrid lens-based fiber optic plug connector 200. In other words, a first alignment feature 55A comprises an alignment pin integrally formed as part of the lens-based ferrule, and the second alignment feature 55B comprises an alignment bore 55B.

As shown, the lens-based ferrule 50 may further comprise an adhesive well 56 configured for receiving an adhesive for securing the plurality of optical fibers 12 terminated by the hybrid fiber optic connector and lens-based ferrule 50. As shown, the adhesive well 56 is disposed rearward of the ferrule front end 51. The adhesive well 56 is partially defined by a mid-ship wall 57 having a plurality of fiber bores therethrough that are aligned with the array of lenses 58 for positioning the optical fibers relative to the array of lenses 58 and aid alignment of the optical fibers with the lenses during manufacture. Lens-based ferrule 50 may also comprise a pocket 54 disposed rearward of the ferrule front end 51 and the mid-ship wall 57. The pocket 54 allows space for easier access for inserting the respective optical fibers 12 into the correct fiber bore in the mid-ship wall 57. The pocket 54 may also include a stepped portion 55 if desired or not. For the sake of simplicity, the same lens-based ferrule 50 is used for both the lens-based hybrid lens-based fiber optic receptacle connector 100 and the assembled hybrid lens-based fiber optic plug connector 200. Further, the lens-based ferrule 50 may be similar or the same as commercially available components for creating and using a common lens interface if desired or not. FIG. 9 depicts a cross-sectional views showing the assembled hybrid lens-based fiber optic receptacle connector 100 and the assembled hybrid lens-based fiber optic plug connector 200 aligned for optical mating.

Other variations of lens-based ferrule 50 may have a first and second alignment features that are the same for each lens-based ferrule 50, thereby requiring different lens-based ferrules for each connector such as two bores integrally formed on a first lens-based ferrule that cooperate with two alignment pins integrally formed on a second lens-based ferrule for optically mating the respective lens-based ferrules.

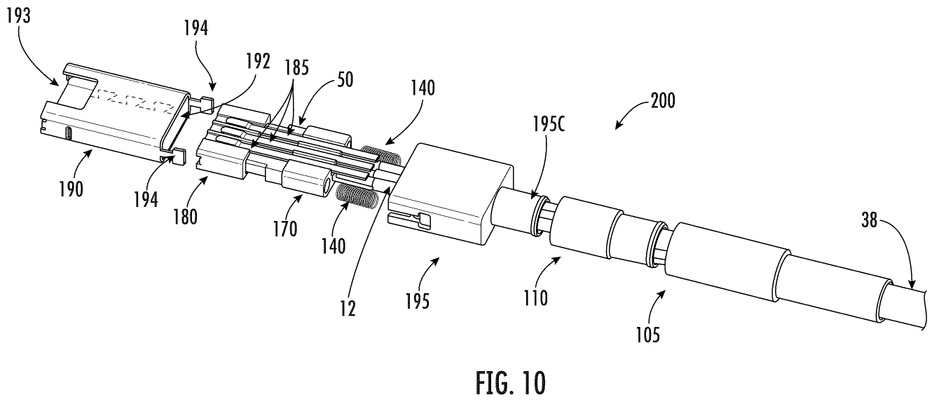

FIG. 10 depicts a partially exploded view of the hybrid lens-based fiber optic plug connector 200 of FIGS. 1 and 1A from the bottom side, and FIG. 11 shows a partially assembled view of the hybrid lens-based fiber optic plug connector 200 of FIG. 10 from the top side. As best shown in FIG. 10, the hybrid lens-based fiber optic plug connector 200 comprises a lens-based ferrule 50, a spring body 170 formed from a dielectric material, a plug body 180 formed from a dielectric material, at least one resilient member 140, a plurality of electrical contacts 185, and a plug housing comprising an inner housing 190 and an outer housing 195. When assembled, the hybrid lens-based fiber optic plug connector 200 is configured for having a portion received within the receptacle housing 90 of the hybrid lens-based fiber optic receptacle connector 100.

The hybrid lens-based fiber optic plug connector 200 has a different construction compared with the hybrid lens-based fiber optic receptacle connector 100. The hybrid lens-based fiber optic plug connector 200 is configured for terminating optical fibers 12 of the hybrid cable 38 of the hybrid cable assembly, and not intended for fixed mounting to an electronic device 100 like the hybrid lens-based fiber optic receptacle connector 100. Consequently, the hybrid lens-based fiber optic plug connector 200 and related hybrid cable assembly has different structure for accommodating the termination and attachment to the hybrid cable 38. Further, the lens-based ferrule 50 of the hybrid lens-based fiber optic plug connector 200 is biased forward in the hybrid plug connector using one or more resilient members 140.

As shown in FIG. 10, the lens-based ferrule 50, the spring body 170, the plug body 180, resilient members 140, electrical contacts 185, and outer housing 195 are removed from the plug housing 190 and show the arrangement of components for assembly into the plug housing 190. The plug body 180 comprises a plug body passageway 182 that extends from a plug body front end 181 to a plug body rear end 183 and is configured for receiving a portion of the lens-based ferrule 50 as shown. When the hybrid lens-based fiber optic plug connector 200 is assembled the lens-based ferrule 50 and plug body 180 are disposed within a passageway 192 of the inner housing 190. The lens-based ferrule 50 may extend entirely through the plug body passageway 182. Further, when assembled the ferrule front end 51 of the lens-based ferrule 50 is flush or slightly protrudes beyond the plug body 180 and plug housing 190 as depicted in FIG. 9.

As shown in FIG. 10, the electrical contacts 185 are positioned to bridge from the plug body 180 to spring body 170. When assembled, the electrical contacts 185 have a front portion 185F exposed in a cutout 199 disposed on a bottom surface of the inner housing 190. The rear portion 185R of the electrical contact 185 may extend rearward of the spring body 170 and be disposed within the cavity of the outer housing 195 when assembled, thereby allowing space for the electrical attachment of electrical conductor of the hybrid cable 38.

Specifically, suitable conductive materials for electrical contacts 85, 185 include copper, brass, copper-clad aluminum, or alloys of such materials such as phosphor copper. Material selection may depend on the requirements for the hybrid lens-based fiber optic connectors such as power requirements, length of the hybrid cable assemblies or the like. Typical power levels for the hybrid cable assemblies may be several amps such as 3-5 amps or more at different voltages such as 5 volts or 3.3 volts depending on the power requirements of the electronic devices 1000 that may use the hybrid cable assemblies or hybrid lens-based fiber optic connectors. Likewise, the sizing of the electrical conductors of any hybrid fiber optic cables may be selected based on the power requirements or the like for the electronic devices 1000.

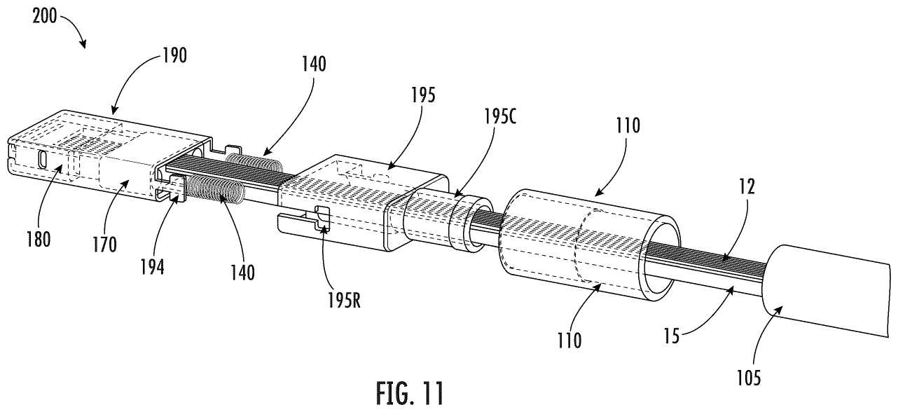

FIGS. 12A-12D depict various views of the spring body 170 of the hybrid lens-based fiber optic plug connector 200. The spring body 170 comprises a forward end 171 and rearward end 172 with at least one bore 175 extending from the rearward end 172. The at least one resilient member 140 is configured for biasing the lens-based ferrule 50 to a forward position, and the at least one resilient member 140 is configured for having a portion received in the at least one bore of the spring body (170). Spring body passageway 172 extends from the forward end 171 to the rearward end 173 of the spring body 170. The spring body passageway 172 also has a stepped profile as best shown in FIG. 12C. The rearward end 173 of the passageway 172 is smaller than the forward end 171 of the passageway 172. The rearward end 173 of the passageway 172 is sized and offset from the centerline for guiding the optical fibers 12 therethrough, and the forward end 171 of the passageway 172 is sized for receiving a portion of the ferrule rear end 53 therein.

The spring body 170 may also comprise a plurality of spring body channels 174. The spring body channels 174 are formed from the spring body front end 171 to the spring body rear end 173 with each spring body channel 174 being configured for receiving a portion of a respective electrical contact 185 therein. The spring body channels 174 are disposed on a bottom surface of the spring body 170 so they may align with the electrical contacts 85 of the hybrid lens-based fiber optic receptacle connector 100.

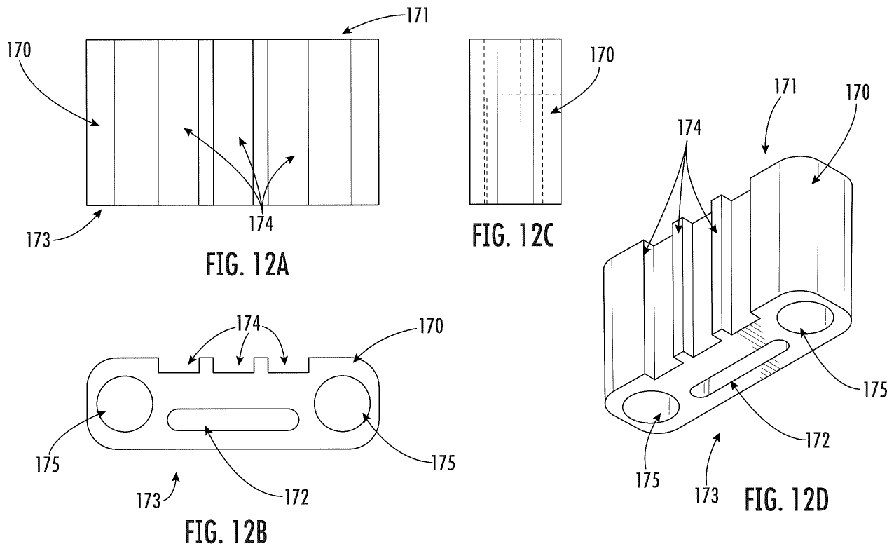

FIGS. 13A-13D depict various views of the plug body 180 of the hybrid lens-based fiber optic plug connector 200. The plug body 180 may also comprise a plurality of plug body channels 184 formed from the plug body front end 181 to the plug body rear end 183 with each plug body channel 184 being configured for receiving a portion of a respective electrical contact 185 therein. The plug body channels 184 are disposed on a bottom surface of the receptacle body 80 so that when assembled the electrical contacts 185 are available for electrical connection such as by wiping contact with the counterpart electrical contacts 85 of the hybrid lens-based fiber optic receptacle connector 100. As depicted the plug body channels 184 may have a stepped profile with the forward portions of the plug body channels being shallower to accommodate the shape of the electrical contacts 185 as shown.

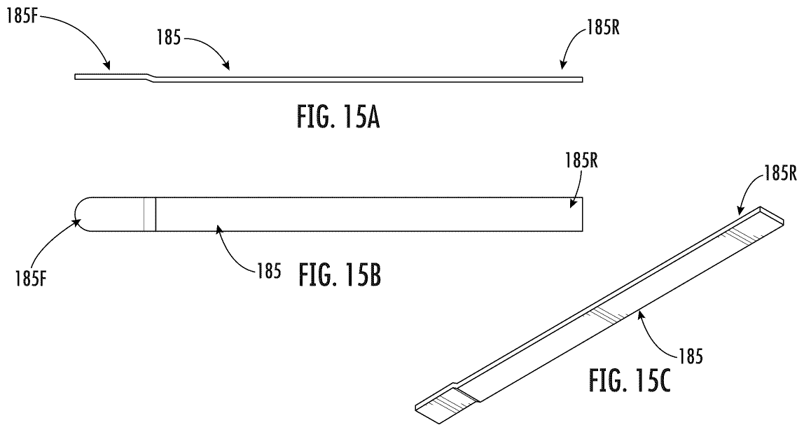

The plug body 180 may also have features to ensure it fully seats into the inner housing 190 for proper assembly such as notches 188 that cooperate with tabs on the inner housing 90. Notches 188 may also act as a forward stop for ensuring that the plug body 80 and in-turn other components are in the proper depth or Z-direction location within the inner housing 190 when assembled. By way of explanation, notches 188 on plug body 180 are configured to engage stops 198 of the inner housing as best shown in FIG. 16D.

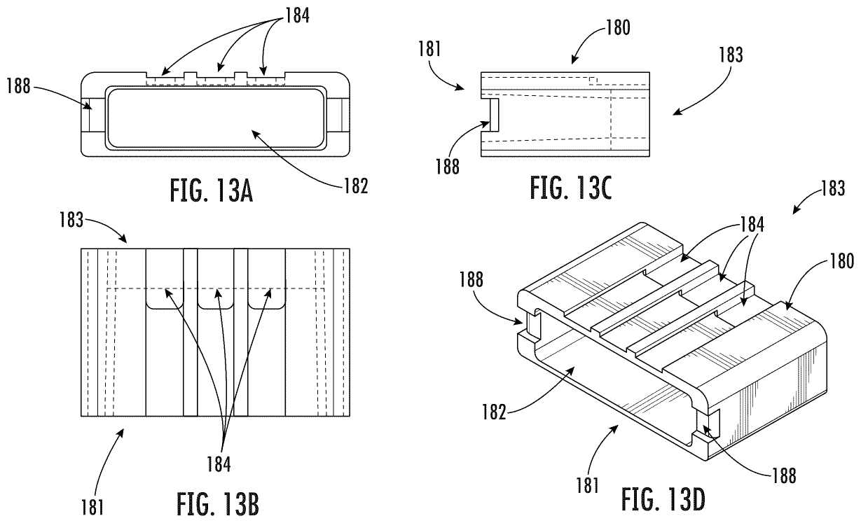

FIGS. 14A-14D depict various views of the outer housing 195 of the hybrid lens-based fiber optic plug connector 200. The outer housing 195 may be formed from a dielectric material and may also act as grip for the hybrid lens-based fiber optic plug connector 200. The outer housing 195 comprises an outer housing passageway 195P extending from an outer housing front end 197 to an outer housing rear end 199 so that the optical fibers 12 and electrical conductors 15 of the hybrid cable 38 may extend therethough for assembly. The outer housing 195 also acts as a rear spring push for the one or more resilient members 140. The optical fibers 12 and electrical conductors 15 may be threaded through the outer housing passageway 195P and the optical fibers 12 are threaded through the other components as appropriate for assembly.

The outer housing rear end 199 may also include a crimp portion 195C. By way of explanation, the crimp portion 195C may have a barrel shape along with a raised rim at the end suitable for strain-relieving components of the hybrid cable 38 if desired. For instance, a crimp body 110 such as a brass tube be deformed capturing or securing strength members and/or the cable jacket of the hybrid cable to the crimp portion 195C for cable strain relief if desired. A heat shrink 110 may also be applied about the deformed crimp body 110 for protecting the interface from the cable to the hybrid lens-based fiber optic plug connector 100 if desired.

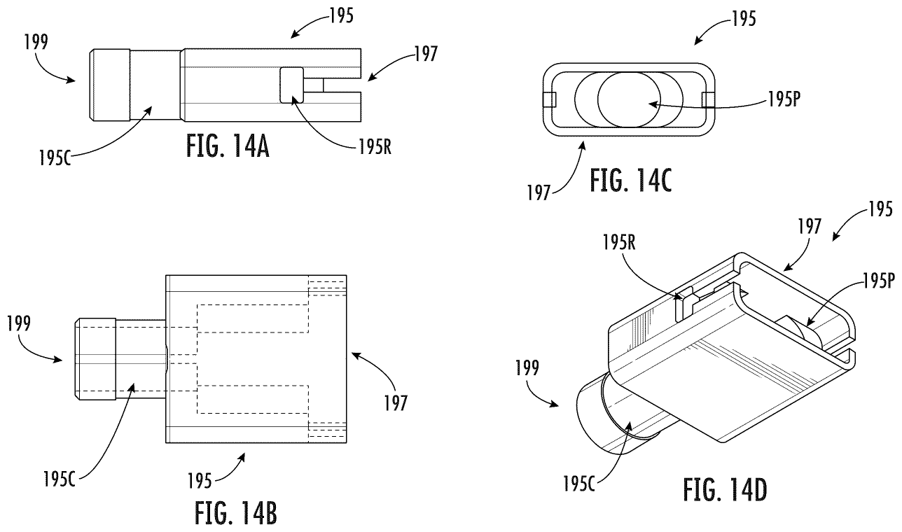

FIGS. 15A-15C depict various views showing the details of the electrical contacts 185 for the hybrid lens-based fiber optic plug connector 200, which may be formed from any suitable conductive material as discussed herein.

FIGS. 16A-16D depict various views of the inner housing 190 of the hybrid lens-based fiber optic plug connector 200. Inner housing 190 comprises an inner housing passageway 192 extending from an inner housing front end 191 to an inner housing rear end 193. The inner housing 190 may be formed from a single piece of suitable sheet metal such as nickel-plated material or the like. Inner housing 190 also includes a plurality of assembly tabs 194 adjacent to the inner housing rear end 193 and disposed on opposing sides of the inner housing 190. The assembly tabs 194 are configured for engaging corresponding structure of the outer housing 195. Specifically, the assembly tabs 194 are configured for engaging the recesses 195R of the outer housing 195, thereby providing a quick and easy assembly between the inner housing 190 and the outer housing once the internal assembly of the hybrid lens-based fiber optic plug connector 200 is completed. For instance, the inner housing 190 may be aligned with the outer housing 195 so that a portion fits into the forward opening of the outer housing 195 and pushed into position until the assembly tabs 194 are fully-seated into the recesses 195R of the outer housing 195. Receptacle housing 90 may also include one or more detents 190D configured as windows for providing a locking feature with the hybrid lens-based fiber optic receptacle connector 100 during optical mating. For instance, the one or more detents 190D of the inner housing 190 may cooperate with the mating latches 97 of the receptacle housing 90 for securing the optical mating of the hybrid lens-based fiber optic plug connector 200 when fully-inserted into the hybrid lens-based fiber optic receptacle connector 100.

The hybrid lens-based fiber optic connectors disclosed may use any suitable fiber optic cables desired. By way of explanation, and not limitation, FIG. 17 is a cross-sectional view of an explanatory cable jacket 30 that may be used with the hybrid cable assembly 10,20 concepts disclosed, but other cable jacket designs are possible. FIGS. 17 and 18 respectively illustrate a representative cable jacket 30 that may form a portion of hybrid cable 38 having a plurality of longitudinal passageways 32,34 suitable for housing and protecting the optical fibers 12 and electrical conductors 15 disposed therein for use with the hybrid cable assemblies 10,20. The use of a hybrid cable 38 or cable jacket 30 is optional for the cable assemblies 10,20 and may be used as desired for protecting the optical fibers 12 and electrical conductors 15. The electrical conductors 15 may have any suitable gauge for the desired power requirements of the electronic devices 1000. For instance, copper conductors may be solid or stranded wire and 14AWG-28AWG, but other gauges may be used and may be based on length of the hybrid cable assembly as well as the power requirements. Cable 38 may also optionally include electrical shielding if desired.

Although the disclosure has been illustrated and described herein with reference to explanatory embodiments and specific examples thereof, it will be readily apparent to those of ordinary skill in the art that other embodiments and examples can perform similar functions and/or achieve like results. For instance, the hybrid lens-based plug or receptacle connectors may omit electrical contacts if desired. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

We claim:

1. A hybrid lens-based fiber optic plug connector comprising:
a lens-based ferrule comprising a ferrule body having a ferrule front end and a ferrule rear end, the ferrule front end comprising one or more alignment features integrally formed in the ferrule body, and an array of lenses disposed at the ferrule front end;
a spring body being formed from a dielectric material, the spring body comprising a forward end and a rearward end with at least one bore extending from the rearward end of the spring body and a spring body fiber passageway extending from the forward end to the rearward end of the spring body;
a plug body comprising a plug body passageway extending from a plug body front end to a plug body rear end, the plug body passageway configured for receiving a portion of the lens-based ferrule;
at least one resilient member configured for biasing the lens-based ferrule to a forward position, wherein the at least one resilient member is configured for having a portion received in at least one bore of the spring body;
a plurality of electrical contacts; and
a plug housing, the plug housing comprising an inner housing and an outer housing.

2. The hybrid lens-based fiber optic plug connector of claim 1, wherein the array of lenses is arranged in a plurality of rows.

3. The hybrid lens-based fiber optic plug connector of claim 1, wherein the plug body further comprises a plurality of plug body channels formed from the plug body front end to the plug body rear end with each plug body channel being configured for receiving a portion of a respective electrical contact therein.

4. The hybrid lens-based fiber optic plug connector of claim 1, wherein the spring body further comprises a plurality of spring body channels formed from the spring body forward end to the spring body rearward end and each spring body channel being configured for receiving a portion of a respective electrical contact.

5. The hybrid lens-based fiber optic plug connector of claim 1, wherein the one or more alignment features comprises at least one alignment pin.

6. The hybrid lens-based fiber optic plug connector of claim 1, wherein the one or more alignment features comprises at least one alignment bore.

7. The hybrid lens-based fiber optic plug connector of claim 1, at least one resilient member being a first resilient member and a second resilient member.

8. The hybrid lens-based fiber optic plug connector of claim 1, wherein the lens-based ferrule further comprises a pocket disposed rearward of the ferrule front end.

9. The hybrid lens-based fiber optic plug connector of claim 1, wherein the lens-based ferrule further comprises an adhesive well configured for receiving an adhesive for securing optical fibers, wherein the adhesive well is disposed rearward of the ferrule front end.

10. The hybrid lens-based fiber optic plug connector of claim 1, further comprising a plurality of the optical fibers terminated to the lens-based ferrule.

11. The hybrid lens-based fiber optic plug connector of claim 10, wherein the plurality of optical fibers comprise a plurality of single-mode optical fibers in optical communication with the array of lenses.

12. The hybrid lens-based fiber optic plug connector of claim 10, wherein the plurality of optical fibers each comprise a respective multi-mode fiber stub attached on a respective end of each one of the plurality of optical fibers at a transition location.

13. The hybrid lens-based fiber optic plug connector of claim 12, wherein each one of the plurality of multi-mode fiber stubs comprises a predetermined length, wherein the predetermined length is configured as an odd multiple of a one-quarter wavelength pitch for a predetermined refractive index profile of the plurality of multi-mode fiber stubs.

14. The hybrid lens-based fiber optic plug connector of claim 12, wherein the transition location is disposed within an adhesive.

15. The hybrid lens-based fiber optic plug connector of claim 1 further comprising a plurality of electrically conductive wires being electrically connected to the respective plurality of electrical contacts.

16. A hybrid lens-based fiber optic receptacle connector, comprising:
a lens-based ferrule comprising a ferrule body having a ferrule front end and a ferrule rear end, the ferrule front end comprising one or more alignment features integrally formed in the ferrule body, and an array of lenses disposed at the ferrule front end;
a plurality of electrical contacts;
a receptacle body formed from a dielectric material, the receptacle body comprising a receptacle body passageway extending from a receptacle body front end to a receptacle body rear end and configured for receiving a portion of the lens-based ferrule and a plurality of receptacle body channels formed from the receptacle body front end to the receptacle body rear end with each receptacle body channel being configured for receiving a portion of a respective electrical contact therein;
a receptacle boot comprising a receptacle boot fiber passageway extending from a receptacle boot front end to a receptacle boot rear end; and
a receptacle housing.

17. The hybrid lens-based fiber optic receptacle connector of claim 16, wherein the array of lenses is arranged in a plurality of rows.

18. The hybrid lens-based fiber optic receptacle connector of claim 16, wherein the one or more alignment features comprises at least one alignment pin.

19. The hybrid lens-based fiber optic receptacle connector of claim 16, wherein the one or more alignment features comprises at least one alignment bore.

20. The hybrid lens-based fiber optic receptacle connector of claim 16, wherein the lens-based ferrule further comprises a pocket disposed rearward of the ferrule front end.

21. The hybrid lens-based fiber optic receptacle connector of claim 16, wherein the lens-based ferrule further comprises an adhesive well configured for receiving an adhesive for securing optical fibers, wherein the adhesive well is disposed rearward of the ferrule front end.

22. The hybrid lens-based fiber optic receptacle connector of claim 16, further comprising an interface pad configured for fitting into the receptacle boot fiber passageway being at least partially disposed between receptable boot and the lens-based ferrule for allowing the lens-based ferrule to tilt during optical mating.

23. The hybrid lens-based fiber optic receptacle connector of claim 16, further comprising a plurality of the optical fibers terminated to the lens-based ferrule.

24. The hybrid lens-based fiber optic plug connector of claim 23, wherein the plurality of optical fibers comprise a plurality of single-mode optical fibers in optical communication with the array of lenses.

25. The hybrid lens-based fiber optic plug connector of claim 23, wherein the plurality of optical fibers each comprise a respective multi-mode fiber stub attached on an end.

26. The hybrid lens-based fiber optic plug connector of claim 25, wherein each one of the plurality of multi-mode fiber stubs comprises a predetermined length, wherein the predetermined length is configured as an odd multiple of a one-quarter wavelength pitch for a predetermined refractive index profile for the plurality of multi-mode fiber stubs.

27. The hybrid lens-based fiber optic plug connector of claim 16 further comprising a plurality of electrically conductive wires being electrically connected to the respective plurality of electrical contacts.

28. The hybrid lens-based fiber optic receptacle connector of claim 16 being a portion of an electronic device.

29. A hybrid cable assembly comprising a hybrid lens-based fiber optic plug connector and a plurality of optical fibers comprising:
a lens-based ferrule comprising a ferrule body having a ferrule front end and a ferrule rear end, the ferrule front end comprising one or more alignment features integrally formed in the ferrule body, and an array of lenses disposed at the ferrule front end;
a spring body being formed from a dielectric material, the spring body comprising a forward end and a rearward end with at least one bore extending from the rearward end of the spring body and a spring body fiber passageway extending from the forward end to the rear end of the spring body;
a plug body comprising a plug body passageway extending from a plug body front end to a plug body rear end, the plug body passageway configured for receiving a portion of the lens-based ferrule;
at least one resilient member configured for biasing the lens-based ferrule to a forward position, wherein the at least one resilient member is configured for having a portion received in at least one bore of the spring body;
a plurality of electrical contacts; and
a plug housing, the plug housing comprising an inner housing and an outer housing, and
the plurality of optical fibers comprise a plurality of single-mode optical fibers in optical communication with the array of lenses and each one of the plurality of optical fibers comprise a respective multi-mode fiber stub attached on a respective end of the plurality of optical fibers at a transition location.

30. The hybrid lens-based fiber optic plug connector of claim 29, wherein each one of the plurality of multi-mode fiber stubs comprises a predetermined length, wherein the predetermined length is configured as an odd multiple of a one-quarter wavelength pitch for a predetermined refractive index profile of the plurality of multi-mode fiber stubs.

31. The hybrid cable assembly of claim 29, wherein the lens-based ferrule further comprises an adhesive well configured for receiving an adhesive for securing optical fibers, wherein the adhesive well is disposed rearward of the ferrule front end, and the respective transition location between the each respective one of the plurality of optical fibers and its respective multi-mode fiber stub is disposed within the adhesive well.

32. A hybrid cable assembly comprising a hybrid lens-based fiber optic receptacle connector and a plurality of optical fibers, the hybrid cable assembly comprising:
a lens-based ferrule comprising a ferrule body having a ferrule front end and a ferrule rear end, the ferrule front end comprising one or more alignment features integrally formed in the ferrule body, and an array of lenses disposed at the ferrule front end;
a plurality of electrical contacts;
a receptacle body formed from a dielectric material, the receptacle body comprising a receptacle body passageway extending from a receptacle body front end to a receptacle body rear end and configured for receiving a portion of the lens-based ferrule and a plurality of receptacle body channels formed from the receptacle body front end to the receptacle body rear end with each receptacle body channel being configured for receiving a portion of a respective electrical contact therein;
a receptacle boot comprising a receptacle boot fiber passageway extending from a receptacle boot front end to a receptacle boot rear end;
a receptacle housing; and
the plurality of optical fibers comprise a plurality of single-mode optical fibers in optical communication with the array of lenses and each one of the plurality of optical fibers comprise a respective multi-mode fiber stub attached on a respective end of the plurality of optical fibers at a transition location.

33. The hybrid lens-based fiber optic plug connector of claim 32, wherein each one of the plurality of multi-mode fiber stubs comprises a predetermined length, wherein the predetermined length is configured as an odd multiple of a one-quarter wavelength pitch for a predetermined refractive index profile of the plurality of multi-mode fiber stubs.

34. The hybrid cable assembly of claim 32, wherein the lens-based ferrule further comprises an adhesive well configured for receiving an adhesive for securing optical fibers, wherein the adhesive well is disposed rearward of the ferrule front end, and the respective transition location between the each respective one of the plurality of optical fibers and its respective multi-mode fiber stub is disposed within the adhesive well.
